(19) United States
(12) Patent Application Publication
(10) Pub. No.: US 2024/0039632 A1
(43) Pub. Date: Feb. 1, 2024

(54) LIGHT RECEIVING DEVICE, RECEPTION DEVICE, COMMUNICATION DEVICE, AND COMMUNICATION SYSTEM

(71) Applicant: NEC Corporation, Tokyo (JP)

(72) Inventors: Koya Takata, Tokyo (JP); Hisashi Mizumoto, Tokyo (JP); Fujio Okumura, Kanagawa (JP)

(73) Assignee: NEC Corporation, Tokyo (JP)

(21) Appl. No.: 18/223,478

(22) Filed: Jul. 18, 2023

(30) Foreign Application Priority Data
Jul. 26, 2022 (JP) 2022-118409

(51) Int. Cl. H04B 10/11; H04B 10/60; G02B 3/00; G02B 19/00

(52) U.S. Cl. CPC H04B 10/11; H04B 10/60; G02B 3/00; G02B 19/0009; G02B 19/0076; G02B 2003/0093

(57) ABSTRACT

Provided is a light receiving device includes a ball lens and a light receiver disposed in a condensing region of the ball lens. The light receiver includes a light receiving element array in which light receiving units each of which includes a light receiving element and an amplifier circuit associated with the light receiving element are disposed in an array, and a selection circuit that selects a light receiving unit included in the light receiving element array.

This application is based upon and claims the benefit of priority from Japanese Patent Application No. 2022-118409, filed on Jul. 26, 2022, the disclosure of which is incorporated herein in its entirety by reference.

### TECHNICAL FIELD

The present disclosure relates to a light receiving device, a reception device, a communication device, and a communication system.

### BACKGROUND ART

In optical spatial communication, optical signals (hereinafter, also referred to as a spatial optical signal) propagating in space are transmitted and received without using a medium such as an optical fiber. In order to receive a spatial optical signal propagating in a wide space, it is preferable to use a lens having as large a diameter as possible. In the optical spatial communication, a light receiving element having a small electrostatic capacitance is used in order to perform high speed communication. Such a light receiving element has a small area of a light receiving section. Since the focal length of the lens is limited, it is difficult to guide spatial optical signals coming from various directions to a light receiving section having a small area using a large-diameter lens.

Patent Literature 1 (JP 2003-258736 A) discloses a sensor for spatial light communication used in a reception device for spatial light communication. The sensor of Patent Literature 1 includes a photoelectric conversion means, a charge storage means, a first signal reading means, and a second signal reading means. The photoelectric conversion means has a structure in which a large number of minute light receiving elements each constituting one pixel are disposed in a two-dimensional matrix. The charge storage means accumulates signal charges generated by photoelectric conversion in each light receiving element in units of pixels. In the first operation mode, the first signal reading means sequentially reads the accumulated signal charges to the outside in units of pixels. The second signal reading means selects one of the light receiving elements included in the photoelectric conversion means in the second operation mode. The second signal reading means adds a signal current generated by photoelectric conversion by the selected light receiving element and reads the added signal current to the outside.

Patent Literature 2 (JP 63-151232 A) discloses an optical reception device that converts a received optical signal into an electrical signal. The light receiving section of the device of Patent Literature 2 includes a condensing lens and a plurality of light receiving elements. The plurality of light receiving elements are disposed close to the condensing lens. The plurality of light receiving elements are divided into a plurality of light receiving faces. The area of each of the divided light receiving faces of the light receiving element increases from the central portion toward the peripheral portion. The area of the light receiving face corresponds to the size of the light spot formed on the light receiving element by the light incident on the lens as the off-axis light flux. Patent Literature 2 discloses an example in which a spherical lens is used as a condensing lens that condenses light in a wide angular range.

Patent Literature 3 (WO 2022/014365 A1) discloses a light receiving element using silicon germanium (SiGe) or germanium (Ge). The element of Patent Literature 3 includes a pixel region in which a plurality of pixels is disposed in a matrix. The plurality of pixels are formed of SiGe or Ge. The element of Patent Literature 3 includes an analog-digital conversion unit provided in units of one or more pixels.

In the method of Patent Literature 1, spatial light communication between a hub and a node disposed in a room is performed using a plurality of light receiving elements disposed in a two-dimensional matrix. In the method of Patent Literature 1, in order to identify the reception unit area by the operation similar to that of the camera, it is necessary to provide a circuit such as an integrator, a memory, and a selector for each light receiving element. In the method of Patent Literature 1, although the position of the communication target disposed in the room can be tracked, it is difficult to use the method for use for tracking communication targets located in various directions outdoors.

In the method of Patent Literature 2 a plurality of light receiving sections of a light receiving element is disposed according to an incident direction of incident light. Therefore, in the method of Patent Literature 2, it is difficult to efficiently receive light unless the incident direction of the incident light is determined. In the method of Patent Literature 2, a large sensor having a special shape is required, and it is difficult to cope with high speed communication.

The method of Patent Literature 3 includes suppressing dark current while increasing quantum efficiency using SiGe or Ge. Patent Literature 3 discloses an example of arraying a plurality of pixels. In the element structure of Patent Literature 3, an insensible field formed between light receiving elements is not optimized, and thus it is difficult to efficiently receive an optical signal.

An object of the present disclosure is to provide a light receiving device, a reception device, a communication device, and a communication system that can efficiently receive an optical signal.

### SUMMARY

A light receiving device according to an aspect of the present disclosure includes a ball lens and a light receiver disposed in a condensing region of the ball lens. The light receiver includes a light receiving element array in which light receiving units each including a light receiving element and an amplifier circuit associated with the light receiving element are disposed in an array, and a selection circuit that selects the light receiving unit included in the light receiving element array.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a reception device according to a first example embodiment;

FIG. 2 is a conceptual diagram illustrating an example of a light receiving face of a light receiver included in the reception device according to the first example embodiment;

FIG. 3 is a conceptual diagram illustrating an example of a configuration of a light receiving unit constituting a light receiving element array included in a light receiver included in the reception device according to the first example embodiment;

FIG. 4 is a conceptual diagram illustrating an example of a circuit configuration of an amplifier circuit included in the light receiving unit constituting the light receiving element array of the light receiver included in the reception device according to the first example embodiment;

FIG. 5 is a conceptual diagram illustrating an example of a circuit configuration of a selection circuit included in the light receiver included in the reception device according to the first example embodiment;

FIG. 6 is a conceptual diagram illustrating an example of selection of the light receiving unit constituting the light receiving element array included in the light receiver included in the reception device according to the first example embodiment;

FIG. 7 is a flowchart for explaining an example of the operation of the reception device according to the first example embodiment;

FIG. 8 is a conceptual diagram illustrating an example of a configuration of a light receiving device according to a first modification of the first example embodiment;

FIG. 9 is a conceptual diagram illustrating an example of a configuration of the light receiving device according to the first modification of the first example embodiment;

FIG. 10 is a conceptual diagram illustrating an example of a configuration of a light receiving device according to a second modification of the first example embodiment;

FIG. 11 is a conceptual diagram illustrating an example of a configuration of the light receiving device according to the second modification of the first example embodiment;

FIG. 12 is a conceptual diagram illustrating an example of a configuration of a light receiving device according to a third modification of the first example embodiment;

FIG. 13 is a conceptual diagram illustrating an example of a configuration of the light receiving device according to the third modification of the first example embodiment;

FIG. 14 is a conceptual diagram illustrating an example of a light receiving face of the light receiver included in the light receiving device according to the third modification of the first example embodiment;

FIG. 15 is a conceptual diagram illustrating an example of a configuration of a light receiver according to a fourth modification of the first example embodiment;

FIG. 16 is a conceptual diagram illustrating an example of a configuration of the light receiver according to the fourth modification of the first example embodiment;

FIG. 17 is a block diagram illustrating an example of a configuration of a communication device according to a second example embodiment;

FIG. 18 is a conceptual diagram illustrating an example of a configuration of a transmission device included in the communication device according to the second example embodiment;

FIG. 19 is a conceptual diagram illustrating an example of a configuration of the communication device according to the second example embodiment;

FIG. 20 is a conceptual diagram for describing an application example of the communication device according to the second example embodiment;

FIG. 21 is a conceptual diagram illustrating an example of a configuration of a light receiving device according to the third example embodiment;

FIG. 22 is a conceptual diagram illustrating an example of a configuration of the light receiving device according to the third example embodiment; and

FIG. 23 is a block diagram illustrating an example of a hardware configuration that performs a process and control according to each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. Aline indicating a trace of light in the drawings is conceptual, and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line. There is a case where hatching is not applied to the cross section for reasons such as an example of a light path is illustrated or the configuration is complicated.

### First Example Embodiment

First, a reception device according to a first example embodiment will be described with reference to the drawings. The reception device of the present example embodiment is used for optical spatial communication in which optical signals (hereinafter, also referred to as a spatial optical signal) propagating in a space are transmitted and received without using a medium such as an optical fiber. The reception device of the present example embodiment may be used for applications other than optical spatial communication as long as the reception device receives light propagating in a space. In the present example embodiment, unless otherwise specified, the spatial optical signal is regarded as parallel light because it comes from a sufficiently distant position. The drawings used in the description of the present example embodiment are conceptual and do not accurately depict an actual structure.

(Configuration)

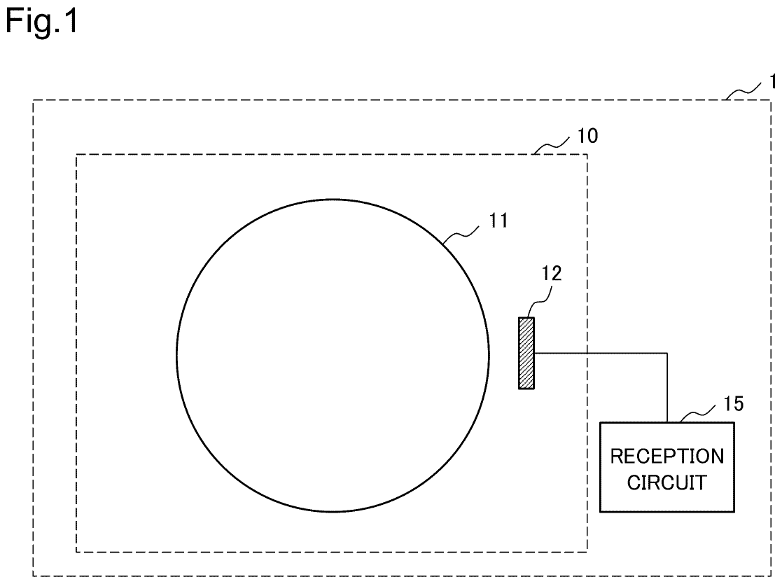

FIG. 1 is a conceptual diagram illustrating an example of a configuration of a reception device 1 according to the present example embodiment. The reception device 1 includes a ball lens 11, a light receiver 12, and a reception circuit 15. The ball lens 11 and the light receiver 12 constitute a light receiving device 10. FIG. 1 is a side view of the light receiving device 10 when viewed from the side. A positional relationship between the ball lens 11 and the light receiver 12 is fixed by a support (not illustrated). In the present example embodiment, the support for fixing the position of the light receiver 12 with respect to the ball lens 11 is omitted. The position of the reception circuit 15 is not particularly limited as long as the reception of the spatial optical signal is not affected.

The ball lens 11 is a spherical lens. The ball lens 11 is an optical element that collects a spatial optical signal arriving from the outside. The ball lens 11 has a spherical shape when viewed from an any angle. The ball lens 11 collects the incident spatial optical signal. Light (also referred to as an optical signal) derived from the spatial optical signal condensed by the ball lens 11 is condensed toward the condensing region of the ball lens 11. Since the ball lens 11 has a spherical shape, the ball lens collects a spatial optical signal coming from an any direction. That is, the ball lens 11 exhibits similar light condensing performance for a spatial optical signal coming from an any direction. The light incident on the ball lens 11 is refracted when entering the inside of the ball lens 11. The light traveling inside the ball lens 11 is refracted again when being emitted to the outside of the ball lens 11. Most of the light emitted from the ball lens 11 is condensed in the condensing region.

For example, the ball lens 11 can be made of a material such as glass, crystal, or resin. In the case of receiving a spatial optical signal in the visible region, a material such as glass, crystal, or resin that transmits/refracts light in the visible region can be applied to the ball lens 11. For example, optical glass such as crown glass or flint glass can be applied to the ball lens 11. For example, crown glass such as Boron Kron (BK) can be applied to the ball lens 11. For example, flint glass such as Lanthanum Schwerflint (LaSF) can be applied to the ball lens 11. For example, quartz glass can be applied to the ball lens 11. For example, a crystal such as sapphire can be applied to the ball lens 11. For example, transparent resin such as acryl can be applied to the ball lens 11.

In a case where the spatial optical signal is light in a near-infrared region (hereinafter, also referred to as near infrared rays), a material that transmits near-infrared rays is used for the ball lens 11. For example, in a case of receiving a spatial optical signal in a near-infrared region of about 1.5 micrometers (μm), a material such as silicon can be applied to the ball lens 11 in addition to glass, crystal, resin, and the like. In a case where the spatial optical signal is light in an infrared region (hereinafter, also referred to as infrared rays), a material that transmits infrared rays is used for the ball lens 11. For example, in a case where the spatial optical signal is an infrared ray, silicon, germanium, or a chalcogenide material can be applied to the ball lens 11. The material of the ball lens 11 is not limited as long as light in the wavelength region of the spatial optical signal can be transmitted/refracted. The material of the ball lens 11 may be appropriately selected according to the required refractive index and use.

The light receiver 12 is disposed in a condensing region including a condensing point of the ball lens 11. The condensing point of the ball lens 11 is not uniquely determined. Therefore, the light receiver 12 is disposed in the condensing region including the condensing point of the ball lens 11. In the example of FIG. 1, the light receiver 12 is disposed on the side of the ball lens 11. The light receiving face of the light receiver 12 is disposed toward the center of the ball lens 11. A plurality of the light receivers 12 may be disposed in an annular portion surrounding the periphery of the ball lens 11. The light receiver 12 may be formed in an annular shape in such a way as to surround the periphery of the ball lens 11.

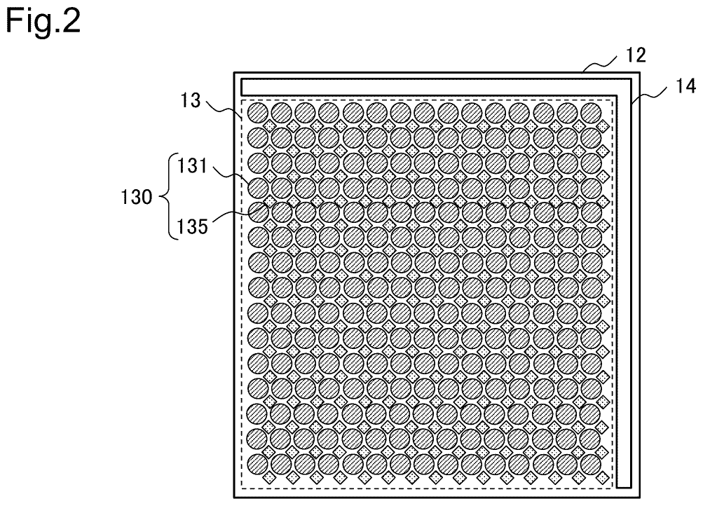

FIG. 2 is a conceptual diagram illustrating an example of a configuration of the light receiver 12. FIG. 2 is a view of the light receiver 12 when viewed toward the light receiving face. The light receiver 12 includes a light receiving element array 13 and a selection circuit 14. The light receiving element array 13 has a configuration in which a plurality of light receiving units 130 is disposed in a two-dimensional array on a light receiving face of the light receiver 12. The light receiving unit 130 includes a pair of a light receiving element 131 and an amplifier circuit 135.

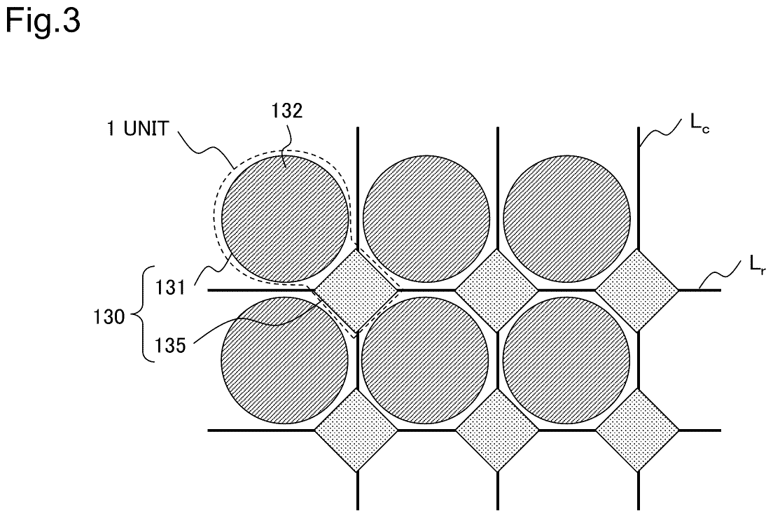

FIG. 3 is a conceptual diagram in which part of the light receiver 12 of FIG. 2 is enlarged. In the case of the example of FIG. 3, the light receiver 131 and the amplifier circuit 135 disposed at the lower right position from the light receiver 131 constitute one light receiving unit 130. Each of the plurality of light receiving elements 131 include a light receiving section 132 that receives an optical signal derived from a spatial optical signal to be received. A circular portion indicates the light receiving section 132 of the light receiving element 131. The light receiving face of each light receiving element 131 includes a region where the light receiving section 132 is located (also referred to as a light receiving region) and a region where the light receiving section 132 is not located (also referred to as an insensible field). The insensible field is formed at a position of a gap between the light receiving sections 132 of the adjacent light receiving elements 131. The optical signal reaching the light receiving region is received by the light receiving section 132 of the light receiving element 131. The optical signal that has reached the insensible field is not received. In the present example embodiment, the amplifier circuit 135 is disposed at the position of the insensible field.

The light receiving section 132 of the light receiving element 131 is directed to the ball lens 11. The optical signal condensed by the ball lens 11 is incident on the light receiving section 132 of each of the plurality of light receiving elements 131. Each of the plurality of light receiving elements 131 receives the optical signal incident on the light receiving section 132. The light receiving element 131 converts the received optical signal into an electrical signal. The converted electrical signal is output to the amplifier circuit 135.

The light receiving element 131 receives light in a wavelength region of the spatial optical signal to be received. For example, the light receiving element 131 has sensitivity to light in the visible region. For example, the light receiving element 131 has sensitivity to light in an infrared region. The light receiving element 131 is sensitive to light having a wavelength in a 1.5 μm (micrometer) band, for example. The wavelength band of light to which the light receiving element 131 has sensitivity is not limited to the 1.5 μm band. The wavelength band of the light received by the light receiving element 131 can be set to any value in accordance with the wavelength of the spatial optical signal transmitted from the transmission device (not illustrated). The wavelength band of the light received by the light receiving element 131 may be set to, for example, a 0.8 μm band, a 1.55 μm band, or a 2.2 μm band. The wavelength band of the light received by the light receiving element 131 may be, for example, a band of 0.8 to 1 μm. A shorter wavelength band is advantageous for optical spatial communication during rainfall because absorption by moisture in the atmosphere is small. When the light receiving element 131 is saturated with intense sunlight, the light receiving element cannot read the optical signal derived from the spatial optical signal. Therefore, a color filter that selectively passes the light of the wavelength band of the spatial optical signal may be installed before the light receiving element 131.

For example, the light receiving element 131 can be achieved by an element such as a photodiode or a phototransistor. For example, the light receiving element 131 is achieved by an avalanche photodiode. The light receiving element 131 achieved by the avalanche photodiode can support high speed communication. The light receiving element 131 may be achieved by an element other than a photodiode, a phototransistor, or an avalanche photodiode as long as an optical signal can be converted into an electrical signal. In order to improve the communication speed, the light receiving section of the light receiving element 131 is preferably as small as possible. For example, the light receiving section of the light receiving element 131 has a square light receiving face having a side of about 5 mm (mm). For example, the light receiving section of the light receiving element 131 has a circular light receiving face having a diameter of about 0.1 to 0.3 mm. The size and shape of the light receiving section of the light receiving element 131 may be selected according to the wavelength band, the communication speed, and the like of the spatial optical signal.

The amplifier circuit 135 is disposed in the insensible field of the light receiving element array 13. The amplifier circuit 135 is paired with any one of the plurality of light receiving elements 131. The amplifier circuit 135 is connected to the light receiving elements 131 as a pair. The amplifier circuit 135 is connected to a column selection line L_{c} and a row selection line Lᵣ. The column selection line L_{c} is shared by the light receiving units 130 of the same column constituting the light receiving element array 13. The column selection line L_{c} is shared with any one of the light receiving units 130 in the same row constituting the light receiving element array 13. An electrical signal output from the light receiving element 131 is input to the amplifier circuit 135. The electrical signal amplified by the amplifier circuit 135 is output to the reception circuit 15 according to selection by the selection circuit 14.

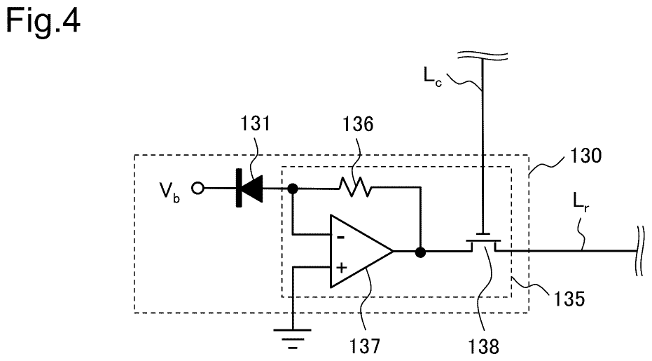

FIG. 4 is a conceptual diagram illustrating an example of a circuit configuration of the amplifier circuit 135. Amplifier circuit 135 includes a resistor 136, an amplifier 137, and a switch 138. A reverse bias voltage V_{b} is applied to the light receiving element 131. The first end of the resistor 136 is connected to the output end of the light receiving element 131. The second end of the resistor 136 is connected to the first end of the switch 138. An inverting input end (−) of the amplifier 137 is connected to the output end of the light receiving element 131. The non-inverting input end (+) of the amplifier 137 is grounded. The output end of the amplifier 137 is connected to the switch 138. The switch 138 is a field effect transistor (FET). The first end of the switch 138 is connected to the second end of the resistor 136 and the output end of the amplifier 137. The second end of the switch 138 is connected to the row selection line Lᵣ used for row selection of the light receiving element array 13. The gate of the switch 138 is connected to the column selection line L_{c} used for column selection of the light receiving element array 13. Agate voltage is applied to the gate of the switch 138 according to the selection of the selection circuit 14. During the time when the gate voltage is applied to the gate of the switch 138, the electrical signal amplified by the amplifier 137 is output to the selection circuit 14. The specifications of the resistor 136, the amplifier 137, and the switch 138 are not limited. The circuit configuration of FIG. 4 is an example, and does not limit the circuit configuration of the amplifier circuit 135. The amplifier circuit 135 may include a circuit configuration other than the resistor 136, the amplifier 137, and the switch 138. The number of resistors 136, or the number of amplifiers 137, or the number of switches 138 included in the amplifier circuit 135 may plural.

The light receiver 12 can be achieved by an integrated circuit (IC) having a structure in which the selection circuit 14 is added to an array formed by a plurality of light receiving units 130 each including the light receiving element 131 and the amplifier circuit 135. For example, the light receiving element 131 can be achieved by a silicon germanium (SiGe)-based or silicon (Si)-based photodiode. A Si-based photodiode can detect a signal in a wavelength band of 800 to 1000 nm. A photodiode including a Ge layer can detect a signal in a wavelength band of 1 μm or more. Ge has sufficient sensitivity even in a wavelength band of 1.5 μm. The photodiode including the Ge layer can be achieved by a stack-type or a lateral type structure. For example, the amplifier circuit 135 can include a complementary metal oxide semiconductor (CMOS). When the light receiving element array 13 is formed in the CMOS circuit formed on the Si substrate, the light receiver 12 can be achieved by a monolithic IC. The light receiver 12 configured by the monolithic IC does not need a compound semiconductor such as indium (in), gallium (Ga), or arsenic (As), and thus can be manufactured at low cost. When configured by a monolithic IC, the light receiver 12 in which the light receiving element 131 capable of operating at high speed is mounted at high density can be achieved.

The configuration of the light receiver 12 of the present example embodiment has a structure similar to that of the imaging element of the camera, but has a circuit configuration different from that of the imaging element of the camera. In the case of the imaging element of the camera, the light amount of each dot is detected by integrating the optical signal of the photodiode for a certain period. Therefore, it is difficult for the imaging element of the camera to be applied to a communication application in which the output of the photodiode is received in real time. The light receiver 12 of the present example embodiment can receive the optical signal condensed at the positions of the plurality of light receiving elements 131 in real time by adding the outputs of the plurality of light receiving elements 131.

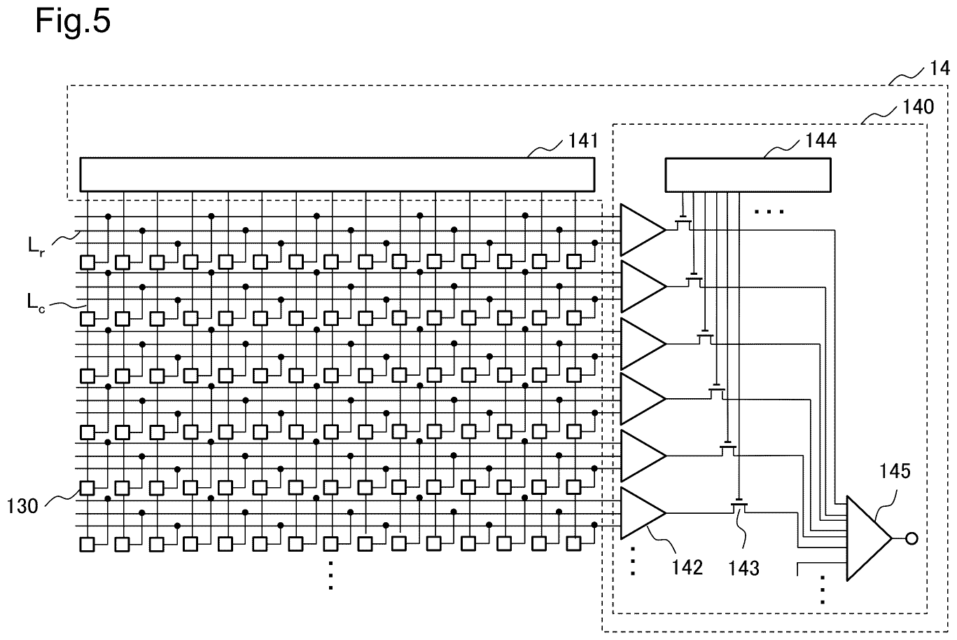

The selection circuit 14 selects the light receiving unit 130 to be used for receiving an optical signal among the plurality of light receiving units 130. FIG. 5 is a conceptual diagram illustrating an example of a configuration of the selection circuit 14 connected to the plurality of light receiving units 130. The selection circuit 14 includes a first selection circuit 141, a plurality of first amplifiers 142, a plurality of switches 143, a second selection circuit 144, and a second amplifier 145. The plurality of first amplifiers 142, the plurality of switches 143, the second selection circuit 144, and the second amplifier 145 constitute an amplifier circuit 140. The circuit configuration of FIG. 5 is an example in which the radiation range of the optical signal is 3 rows×3 columns. The radiation range of the optical signal is not limited to the range of 3 rows×3 columns. The radiation range of the optical signal is determined by the distance between the ball lens 11 and the light receiving unit 130. For example, the radiation range of the optical signal may be 2 rows×2 columns or 4 rows×4 columns according to the distance between the ball lens 11 and the light receiving unit 130. The radiation range of the optical signal may be different in the number of rows and columns, such as 2 rows×3 columns or 3 rows×4 columns.

The first selection circuit 141 (also referred to as a scanning circuit) is connected to the plurality of column selection lines L_{c}. The column selection line L_{c} is connected to the plurality of light receiving units 130 disposed in the same column constituting the light receiving element array 13. The column selection line L_{c} is connected to the gate of the switch 138 included in the amplifier circuit 135 of the light receiving unit 130. Under the control of the reception circuit 15, the first selection circuit 141 applies a gate voltage to the gate of the switch 138 included in the amplifier circuit 135 of the light receiving unit 130 disposed in the same column via the column selection line L_{c}.

The input end of the first amplifier 142 is connected to the row selection line Lᵣ connected to a plurality of light receiving units 130 disposed in the same row among the plurality of light receiving units 130 constituting the light receiving element array 13. When the radiation range of the optical signal is 3 rows×3 columns, 3 row selection lines Lᵣ are connected to the input ends of the first amplifiers 142 as illustrated in FIG. 5. The number of row selection lines Lᵣ connected to the input ends of the first amplifiers 142 may be set according to the number of light receiving units 130 included in the radiation range of the optical signal. The output end of the first amplifier 142 is connected to the first end of any one of the plurality of switches 143. The electrical signal output from the light receiving unit 130 connected to the selected column selection line L_{c} is input to the first amplifier 142. The first amplifier 142 adds/amplifies the input electrical signal to output the resultant signal.

The switch 143 is an analog switch used to select the column selection line L_{c}. For example, the switch 143 is achieved by a field effect transistor (FET). The first end of the switch 143 is connected to the output end of the first amplifier 142. The second end of the switch 143 is connected to the input end of the second amplifier 145. The gate of the switch 143 is connected to the second selection circuit 144. A gate voltage is applied to the gate of the switch 143 according to the selection of the second selection circuit 144. During the time when the gate voltage is applied to the gate of the switch 143, the electrical signal amplified by the first amplifier 142 is output to the second amplifier 145. The type of the switch 143 is not particularly limited as long as the analog switch function is performed. For example, the switch 143 in which p-type and n-type FETs are combined may be configured. The switch 143 in which p-type and n-type FETs are combined is advantageous in the voltage range. For example, the switch 143 may be achieved by a bipolar transistor.

The second selection circuit 144 is connected to gates of the plurality of switches 143. The first selection circuit 141 selects the switch 143 connected to any row under the control of the reception circuit 15. The second selection circuit 144 applies a gate voltage to the gate of the selected switch 143. According to the selection by the second selection circuit 144, the switch 143 in which the gate voltage is applied to the gate transitions to the ON state. The electrical signal amplified by the first amplifier 142 connected to the switch 143 selected by the second selection circuit 144 is output to the second amplifier 145.

The input end of the second amplifier 145 is connected to the second ends of the plurality of switches 143. The output end of the second amplifier 145 is connected to the reception circuit 15. In the case of the example of FIG. 5, the electrical signal amplified by the first amplifier 142 is input to the second amplifier 145 according to the selection of one of the switches 143. The second amplifier 145 adds/amplifies the input electrical signal. The added/amplified electrical signal is output to the reception circuit 15.

The reception circuit 15 acquires the electrical signal output from the light receiver 12. The reception circuit 15 operates in two modes of a search mode and a communication mode. In the search mode, the reception circuit 15 controls the selection circuit 14 in such a way as to select a predetermined number of light receiving units 130 for each row. The reception circuit 15 monitors outputs of electrical signals acquired from a predetermined number of light receiving units. The reception circuit 15 sequentially monitors the outputs of the electrical signals amplified by the predetermined number of light receiving units 130. The reception circuit 15 identifies the plurality of light receiving units 130 used for communication according to the output of the electrical signal for each predetermined number of light receiving units 130. For example, when the output of the electrical signal for each of the predetermined number of light receiving units 130 exceeds the threshold value, the reception circuit 15 uses the identified light receiving units 130 for communication.

For example, in the search mode, the reception circuit 15 controls the selection circuit 14 in such a way as to select the light receiving elements 131 within the range of 3 columns among the plurality of light receiving units 130. For example, the reception circuit 15 selects 3 columns at the upper left position in FIG. 5. The reception circuit 15 sequentially shifts the range of 3 columns in the right direction by one column from the upper left position and sequentially moves the range over one row to monitor the output of the electrical signal. When the scan of the upper right position is completed, the reception circuit 15 monitors the output of the electrical signal from left to right for the next row. When scanning of all the rows and columns is completed, the reception circuit 15 identifies a range including the light receiving unit 130 having the largest output of the electrical signal. The reception circuit 15 selects the plurality of light receiving units 130 within the identified range. For example, the reception circuit 15 selects the light receiving units 130 in a range of 3 rows×3 columns.

In the communication mode, the reception circuit 15 receives the electrical signals output from the light receiving units 130 identified in the search mode. That is, in the communication mode, the reception circuit 15 receives the electrical signal derived from the spatial optical signal transmitted from the communication target using the plurality of light receiving units 130 selected in the search mode. The reception circuit 15 decodes the received electrical signal. The reception circuit 15 outputs the decoded signal. The signal decoded by the reception circuit 15 is used for any purpose. The use of the signal decoded by the reception circuit 15 is not particularly limited.

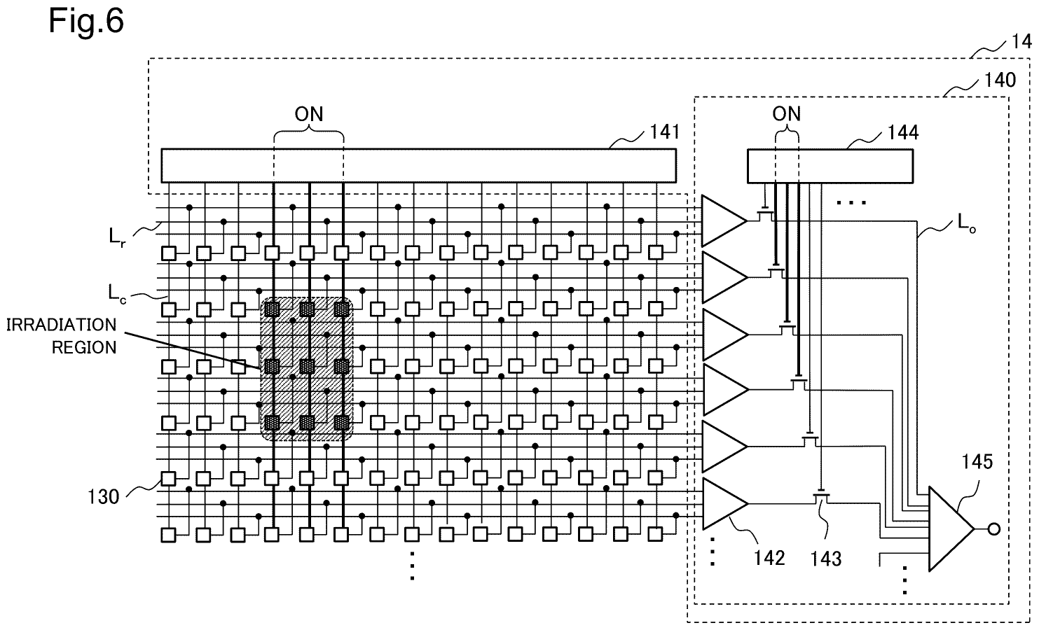

FIG. 6 is a conceptual diagram illustrating an example in which some of the plurality of light receiving units 130 are selected. In the example of FIG. 6, a range of 3 rows×3 columns is selected. The selected range of 3 rows×3 columns is included in the irradiation region irradiated with the optical signal. The range of 3 rows×3 columns is selected by selecting the 3 rows of row selection lines Lᵣ for and the 3 columns of column selection lines L_{c}. The 3 rows of row selection lines Lᵣ are selected according to the application of the voltage to the gate of the switch 143 by the second selection circuit 144. The 3 columns of column selection lines L_{c} are selected by the first selection circuit 141. The reception circuit 15 decodes the signal output from the selected light receiving unit 130. For example, when it is assumed that communication is performed at 600 megahertz in order to perform communication at one gigabit per second, it takes less than two nanoseconds per output. When the plurality of light receiving units 130 has 15 rows×15 columns, it takes 30 nanoseconds to scan 15 columns, and it takes 450 nanoseconds to output 15 rows. That is, the search mode ends in one microsecond or less. This degree of time is much shorter than the time when communications are lost due to rain particles. Therefore, in the reception device 1 of the present example embodiment, the influence of the time required for the search mode on the communication can be almost ignored.

The reception circuit 15 switches from the communication mode to the search mode at a predetermined timing, and detects a change in a spot of the optical signal. By operating in this manner, even when the communication environment with the communication target changes, the reception device 1 can continue communication with the communication target. For example, the predetermined timing is set based on an elapsed time from a time point at which the search mode is switched to the communication mode. For example, the predetermined timing may be dynamically set according to a decrease in the output of the electrical signal. The control function of selecting and controlling the light receiving unit 130 may be provided not in the reception circuit 15 but in the selection circuit 14. In this case, the reception circuit 15 decodes the electrical signal received by the light receiving unit 130 selected according to the control of the control function of the selection circuit 14.

(Operation)

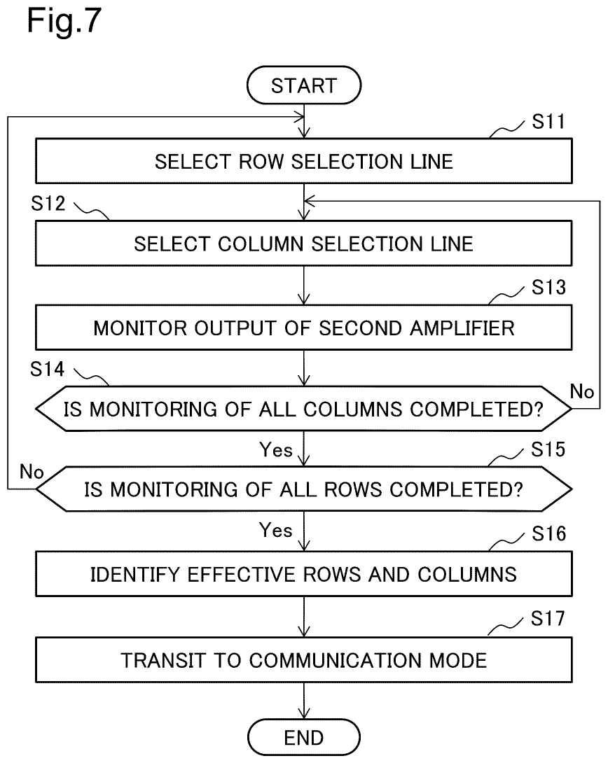

Next, an example of the operation of the reception device 1 according to the present example embodiment will be described with reference to the drawings. Hereinafter, the operation of the reception circuit 15 included in the reception device 1 will be described. FIG. 7 is a flowchart for explaining an example of the operation of the reception circuit 15. The flowchart of FIG. 7 relates to processing from the search mode to the communication mode. In the description along the flowchart of FIG. 7, the reception circuit 15 will be described as an operation subject.

In FIG. 7, first, reception circuit 15 selects a row selection line (step S11). For example, the reception circuit 15 controls the selection circuit 14 in such a way as to select the row selection line connected to the light receiving units 130 disposed in the uppermost row in the examples of FIGS. 5 to 6. The selection circuit 14 applies a gate voltage to the gate of the switch 143 connected to the first amplifier 142 associated with the selected row selection line according to the control of the reception circuit 15.

Next, the reception circuit 15 selects a column selection line (step S12). For example, the reception circuit 15 controls the selection circuit 14 in such a way as to select the column selection line connected to the plurality of light receiving units 130 disposed in the leftmost column in the examples of FIGS. 5 to 6. The selection circuit 14 applies a gate voltage to the selected column selection line under the control of the reception circuit 15. The light receiving units 130 connected to the selected column selection line output electrical signals corresponding to the optical signals received by the light receiving elements 131 included in the light receiving units 130.

Next, the reception circuit 15 monitors the output of the second amplifier 145 (step S13). The reception circuit 15 stores the output monitored during the period of the search mode in a storage unit (not illustrated).

When the monitoring of all the columns is completed (Yes in step S14), the reception circuit 15 advances the process to the process of step S15. When the monitoring of all the columns is not completed (No in step S14), the reception circuit 15 returns the process to the process of step S12 and selects a column selection line of the next column. For example, the reception circuit 15 selects column selection lines from left to right in the examples of FIGS. 5 to 6.

In the case of Yes in step S14, when monitoring of all the rows is completed (Yes in step S15), the reception circuit 15 selects effective rows and columns (step S16). The effective rows and columns are a group including the light receiving unit 130 in which the output of the second amplifier 145 is the largest. For example, a plurality of light receiving units 130 of 3 rows×3 columns constitute one group. The number of the light receiving units 130 constituting the group may be set in advance according to the reception situation of the spatial optical signal and the like. When the monitoring of all the rows is not completed (No in step S15), the reception circuit 15 returns the process to the process of step S11 and selects the row selection line of the next row. For example, the reception circuit 15 selects row selection lines from top to bottom in the examples of FIGS. 5 to 6.

After step S16, the reception circuit 15 transitions to the communication mode (step S17). In the communication mode, the reception circuit 15 acquires signals output from the identified rows and columns. The reception circuit 15 decodes the acquired signal. For example, the reception circuit 15 outputs decoded data. For example, data output from the reception circuit 15 is used by a communication device (not illustrated) including the reception device 1. The use of the decoded data is not limited.

(Modifications)

Next, some modifications of the light receiving device 10 of the present example embodiment will be described. The following modifications are merely examples, and do not limit variations of the light receiving device 10.

[First Modification]

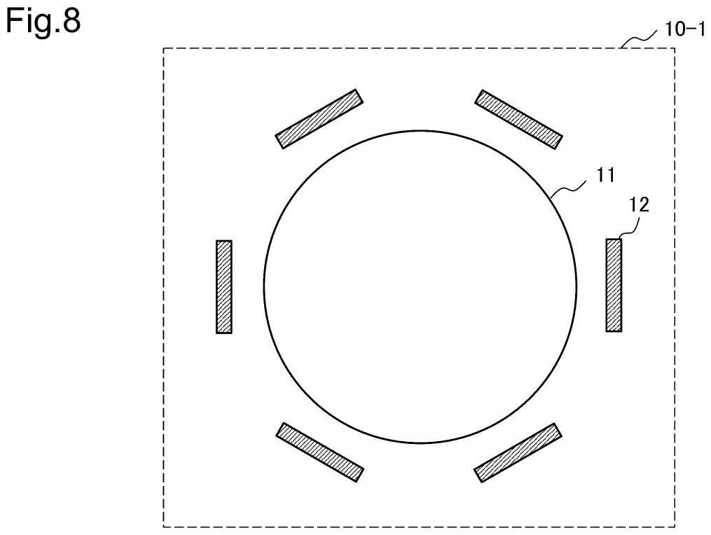

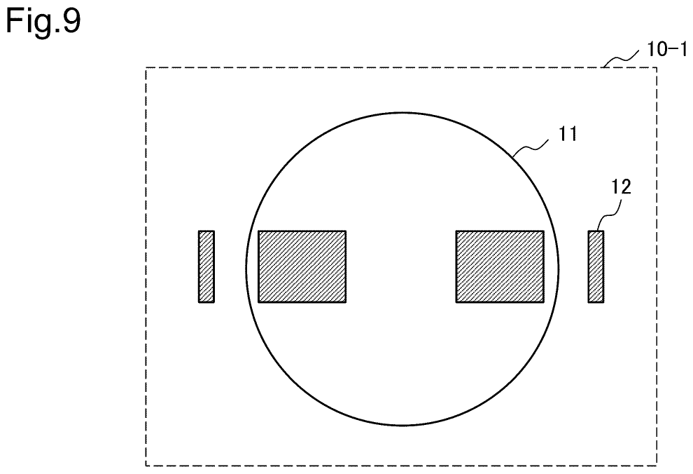

FIGS. 8 to 9 are conceptual diagrams illustrating an example of a configuration of a light receiving device 10-1 according to the first modification. FIG. 8 is a plan view of the light receiving device 10-1 when viewed from the top. FIG. 9 is a side view of the light receiving device 10-1 when viewed from the side.

The light receiving device 10-1 of the present modification includes the ball lens 11 and the plurality of light receivers 12. The light receiving device 10-1 of the present modification includes six light receivers 12. The plurality of light receivers 12 is disposed at equal intervals in such a way as to surround the ball lens 11. The light receiving faces of the plurality of light receivers 12 are directed to the ball lens 11. A positional relationship between the ball lens 11 and the plurality of light receivers 12 is fixed by a support (not illustrated). The plurality of light receivers 12 may be disposed at different intervals. The number of the plurality of light receivers 12 is not particularly limited.

The light receiving device 10-1 of the present modification can receive the spatial optical signal condensed on the light receiving face of any of the light receiving device 10-1. The light receiving device 10-1 of the present modification can receive spatial optical signals coming from various directions as compared with the light receiving device 10 of FIG. 1.

[Second Modification]

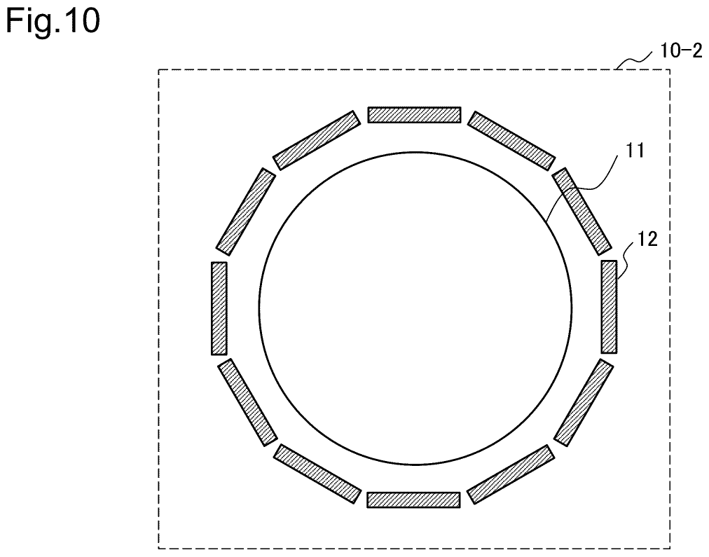

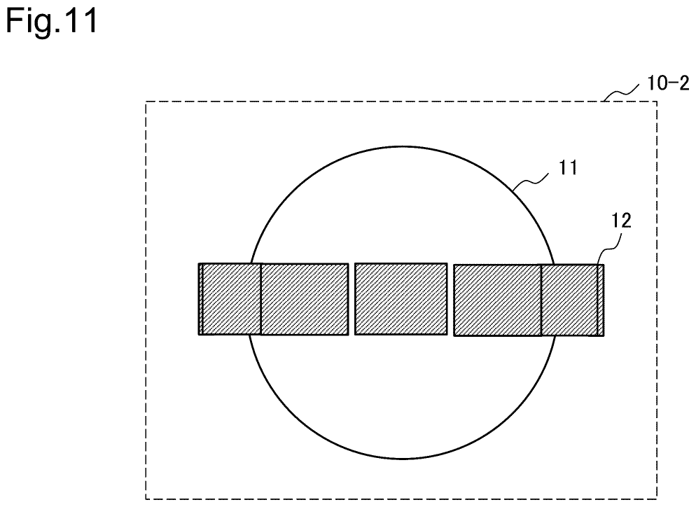

FIGS. 10 to 11 are conceptual diagrams illustrating an example of a configuration of a light receiving device 10-2 according to the second modification. FIG. 10 is a plan view of the light receiving device 10-2 when viewed from the top. FIG. 11 is a side view of the light receiving device 10-2 when viewed from the side.

The light receiving device 10-2 of the present modification includes the ball lens 11 and the plurality of light receivers 12. The light receiving device 10-1 of the present modification includes 12 light receivers 12. The plurality of light receivers 12 is disposed at equal intervals with as few gaps as possible in such a way as to surround the ball lens 11. The light receiving faces of the plurality of light receivers 12 are directed to the ball lens 11. A positional relationship between the ball lens 11 and the plurality of light receivers 12 is fixed by a support (not illustrated). The number of the plurality of light receivers 12 is not particularly limited.

The light receiving device 10-2 of the present modification can receive the spatial optical signal condensed on any light receiving face of the plurality of light receiving device 10-2. The light receiving device 10-2 of the present modification can receive the spatial optical signals coming from various directions as compared with the light receiving device 10-1 of the first modification.

[Third Modification]

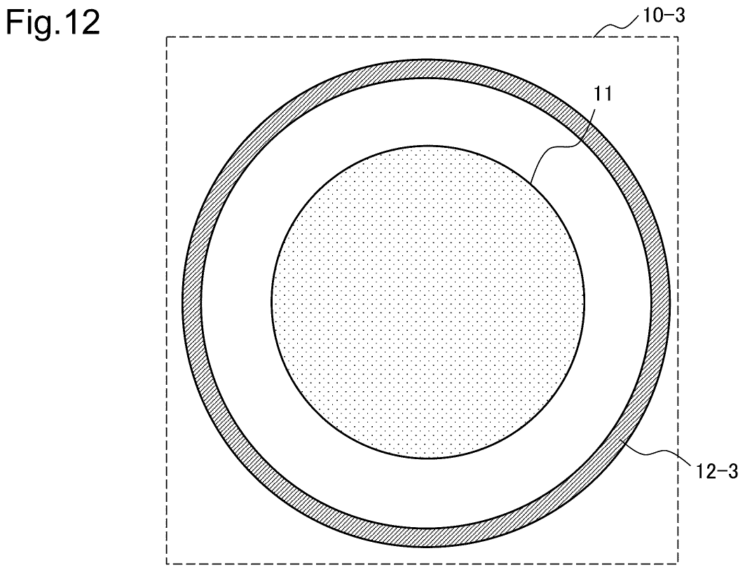

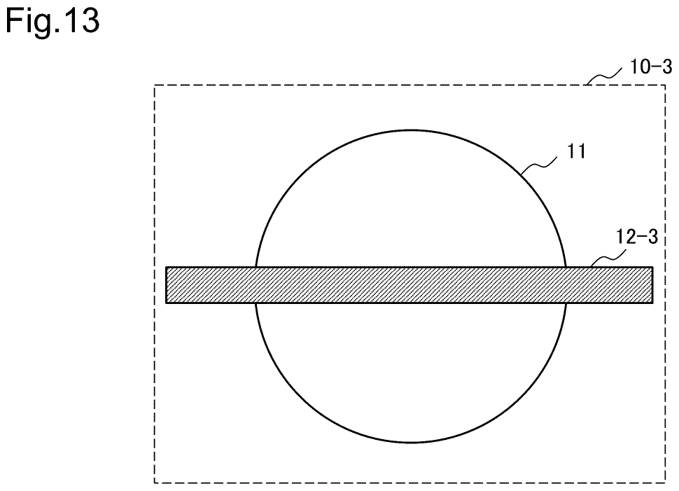

FIGS. 12 to 13 are conceptual diagrams illustrating an example of a configuration of a light receiving device 10-3 according to the third modification. FIG. 12 is a plan view of the light receiving device 10-3 when viewed from the top. FIG. 13 is a side view of the light receiving device 10-3 when viewed from the side.

The light receiving device 10-3 of the present modification includes the ball lens 11 and a light receiver 12-3. The light receiver 12-3 is formed in an annular shape. The light receiving face of the light receiver 12-3 faces the inside of the ring. The light receiver 12-3 is disposed in such a way as to surround the ball lens 11. The light receiving face of the light receiver 12-3 faces the ball lens 11. A positional relationship between the ball lens 11 and the light receiver 12-3 is fixed by a support (not illustrated).

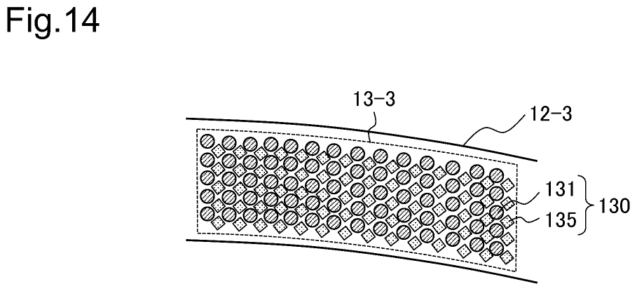

FIG. 14 is a conceptual diagram illustrating part of the light receiving face of the light receiver 12-3. A light receiving element array 13-3 including a plurality of light receiving units 130 is formed on a light receiving face of the light receiver 12-3. The light receiving unit 130 includes a pair of a light receiving element 131 and an amplifier circuit 135. For example, the light receiver 12-3 can be achieved by bending a flexible substrate on which the light receiving element array 13 and a selection circuit (not illustrated) are formed into an annular shape with a light receiving face facing inward. For example, the light receiver 12-3 can be achieved by attaching the single-crystalline silicon-based light receiving element 131 and the amplifier circuit 135 formed on a silicon substrate to a flexible substrate by a device transfer technique. For example, the light receiver 12-3 can be achieved by forming the low temperature polysilicon type light receiving element 131 and the amplifier circuit 135 on a thin glass substrate. The light receiver 12-3 can be achieved by forming the low temperature polysilicon type light receiving element 131 and the amplifier circuit 135 on a thin glass substrate.

Alternatively, device transfer is also performed over a large area.

The light receiving device 10-3 of the present modification can receive a spatial optical signal coming from a direction of 360 degrees in a horizontal plane. In the light receiving device 10-3 of the present modification, there is no gap between the adjacent light receivers 12. The light receiving section of the light receiving element 131 of the light receiver 12-3 included in the light receiving device 10-3 of the present modification can be disposed along the condensing portion of the ball lens 11. Therefore, the light receiving device 10-3 of the present modification can efficiently receive the spatial optical signals coming from various directions as compared with the light receiving device 10-2 of the second modification.

[Fourth Modification]

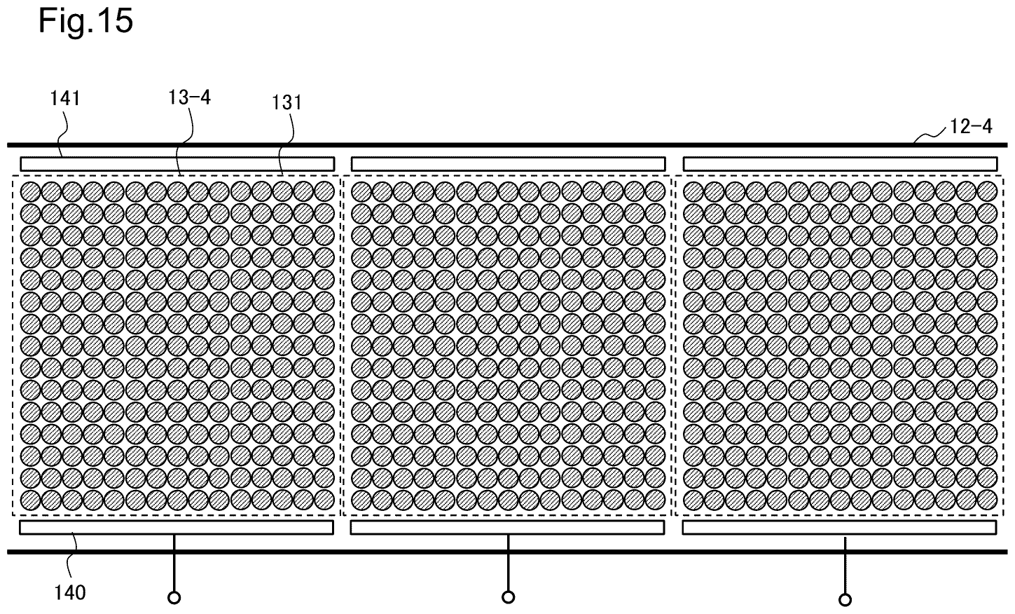

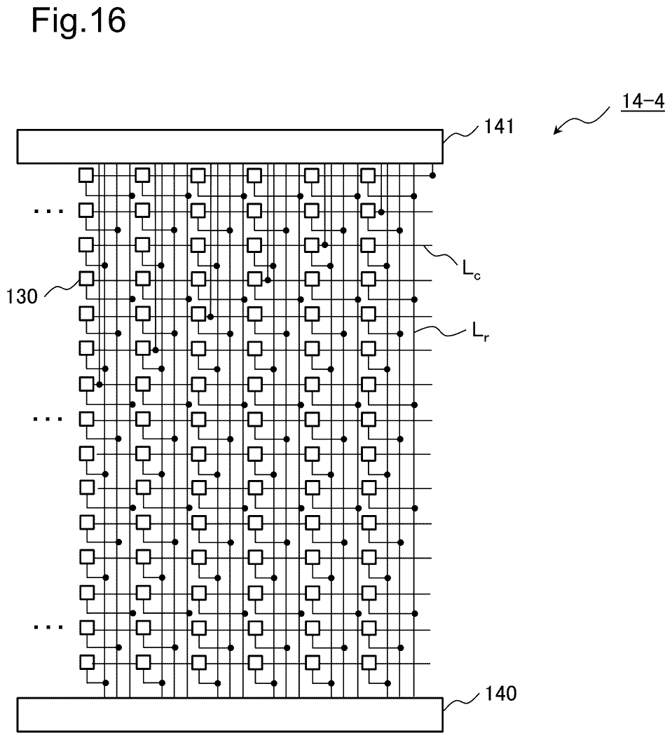

FIGS. 15 to 16 are conceptual diagrams for describing a light receiver 12-4 according to the fourth modification. The light receiver 12-4 of the present modification is disposed in such a way as to surround the periphery of the ball lens 11, as in the light receiver 12-3 of the third modification. FIG. 15 is a conceptual diagram of the light receiver 12-4 when viewed toward the light receiving face. FIG. 16 is a conceptual diagram illustrating an example of a configuration of a selection circuit 14-4 connected to the plurality of light receiving units 130 included in the light receiver 12-4. The plurality of light receiving units 130 is not included in the selection circuit 14-4.

The light receiver 12-4 is formed in an annular shape. The light receiving face of the light receiver 12-4 faces the inside of the ring. The light receiver 12-4 is disposed in such a way as to surround the ball lens 11 as in the third modification (FIGS. 12 to 13). The light receiving face of the light receiver 12-4 faces the ball lens 11. A positional relationship between the ball lens 11 and the light receiver 12-4 is fixed by a support (not illustrated).

A light receiving element array 13-4 including a plurality of light receiving units 130 is formed on a light receiving face of the light receiver 12-4. The first selection circuit 141 (scanning circuit) is disposed above the light receiving element array 13-4. The amplifier circuit 140 is disposed below the light receiving element array 13-4. Since the circuit configurations of the first selection circuit 141 and the amplifier circuit 140 are similar to those in the examples of FIGS. 5 to 6, detailed description thereof will be omitted. For example, the light receiver 12-4 is achieved by bending the flexible substrate on which the light receiving element array 13, the first selection circuit 141, and the amplifier circuit 140 are formed into an annular shape with the light receiving face facing inward.

When the light receiver 12-4 of the present modification is used, it is possible to receive a spatial optical signal coming from a direction of 360 degrees in a horizontal plane. In the light receiver 12-4 of the present modification, the plurality of light receiving element arrays 13-4 can be disposed without a gap by disposing the selection circuits above and below the light receiving element array 13-4. Therefore, according to the light receiver 12-4 of the present modification, the spatial optical signals coming from various directions can be more efficiently received as compared with the light receiving device 10-3 of the third modification.

As described above, the reception device of the present example embodiment includes the ball lens, the light receiver, and the reception circuit. The ball lens and the light receiver constitute the light receiving device. The ball lens is a spherical lens. The light receiver is disposed in the condensing region of the ball lens. The light receiver includes the light receiving element array and the selection circuit. The light receiving element array has a configuration in which light receiving units are disposed in an array. The light receiving unit includes the light receiving element and the amplifier circuit. The amplifier circuit is associated with one of the plurality of light receiving elements. The selection circuit selects the light receiving unit included in the light receiving element array. The reception circuit obtains a signal received by the light receiving device. The reception circuit decodes the acquired signal.

The light receiving device of the present example embodiment condenses the spatial optical signal transmitted from the communication target by the ball lens. The optical signal condensed by the ball lens is condensed toward at least one of the plurality of light receiving elements constituting the light receiving element array. The light receiving element included in the light receiving unit disposed at the position where the optical signal is condensed receives the condensed optical signal. The light receiving element converts the received optical signal into an electrical signal. The amplifier circuit included in the same light receiving unit as the light receiving element amplifies and outputs the converted electrical signal. According to the reception device of the present example embodiment, an optical signal can be efficiently received.

In an aspect of the present example embodiment, the amplifier circuit is disposed adjacent to the associated light receiving element in the insensible field formed in the gap between the plurality of light receiving elements disposed in the array. In the present aspect, the amplifier circuit is disposed in an insensible field which is a region not used in receiving an optical signal. Therefore, according to the present aspect, the insensible field can be effectively used. In the present aspect, the light receiving element and the amplifier circuit constituting the light receiving unit are disposed adjacent to each other. Therefore, according to the present aspect, since the wiring between the light receiving element and the amplifier circuit can be omitted, the device configuration can be simplified.

In an aspect of the present example embodiment, the light receiving element array includes a silicon-based or silicon-germanium-based light receiving element formed in an array on a silicon substrate. According to the present aspect, since the light receiving element array can be configured in a monolithic manner, the manufacturing cost can be reduced. According to the present aspect, since light receiving elements capable of high-speed operation can be mounted at high density, light receiving efficiency of an optical signal can be improved.

In an aspect of the present example embodiment, the selection circuit includes the first selection circuit, the plurality of first amplifiers, the second amplifier, the plurality of switches, and the second selection circuit. The first selection circuit is connected to a column selection line used to select a plurality of light receiving units disposed in the same column among a plurality of light receiving units disposed in an array. The first amplifier is disposed in association with the plurality of light receiving units disposed in the same row among the plurality of light receiving units disposed in an array. The first amplifier is connected to a plurality of row selection lines connected to an output of at least any of the plurality of light receiving units disposed in the same row. The first amplifier adds and amplifies the electrical signals input via the plurality of row selection lines. Outputs of the plurality of first amplifiers are connected to the second amplifier. The second amplifier adds and amplifies the input electrical signals. The switch is disposed for each of the plurality of first amplifiers. The second selection circuit selects a plurality of light receiving units disposed in at least any one row among a plurality of light receiving units disposed in an array using a switch disposed for each of the plurality of first amplifiers. According to the present aspect, a desired light receiving unit to be used for receiving an optical signal can be selected from the plurality of light receiving units constituting the light receiving element array.

In an aspect of the present example embodiment, a plurality of light receivers is disposed in a condensing region of a ball lens. According to the present aspect, spatial optical signals coming from various directions can be received.

In an aspect of the present example embodiment, the light receiver is formed in an annular shape with the light receiving face facing inward. The light receiver is disposed in the condensing region of the ball lens. According to the present aspect, spatial optical signals coming from various directions can be efficiently received.

In an aspect of the present example embodiment, the reception circuit sequentially selects a predetermined number of light receiving units in the search mode. The reception circuit identifies the light receiving unit used for communication according to the outputs of the selected predetermined number of light receiving units. In the communication mode, the reception circuit receives the optical signal derived from the spatial optical signal transmitted from the communication target using the light receiving unit identified in the search mode. According to the present aspect, in the search mode, the light receiving unit used to receive the optical signal can be identified. According to the present aspect, in the communication mode, an optical signal can be efficiently received using the light receiving unit identified in the search mode.

### Second Example Embodiment

Next, a communication device according to a second example embodiment will be described with reference to the drawings. The communication device of the present example embodiment has a configuration in which a reception device and a transmission device are combined. The reception device has the configuration of the first example embodiment. The transmission device transmits a spatial optical signal. Hereinafter, an example of a transmission device including a transmission device including a phase modulation-type spatial light modulator will be described. The communication device of the present example embodiment may include a transmission device including a light transmission function that is not a phase modulation-type spatial light modulator.

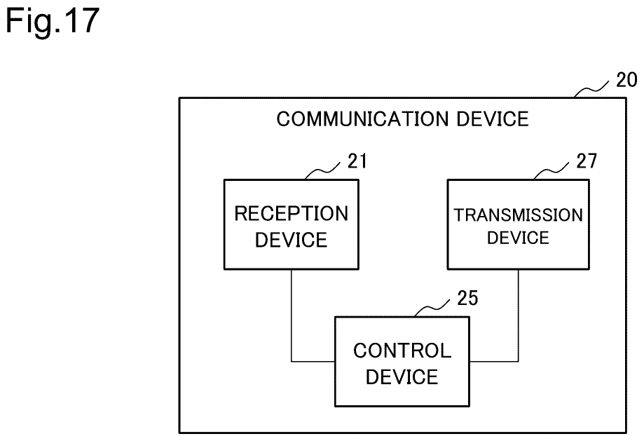

FIG. 17 is a conceptual diagram illustrating an example of a configuration of a communication device 20 of the present example embodiment. The communication device 20 includes a reception device 21, a control device 25, and a transmission device 27. The communication device 20 transmits and receives spatial optical signals to and from an external communication target. Therefore, an opening or a window for transmitting and receiving a spatial optical signal is formed in the communication device 20.

The reception device 21 is a reception device of the first example embodiment.

The reception device 21 receives a spatial optical signal transmitted from a communication target (not illustrated). The reception device 21 converts the received spatial optical signal into an electrical signal. The reception device 21 outputs the converted electrical signal to the control device 25.

The control device 25 acquires a signal output from the reception device 21.

The control device 25 performs a process according to the acquired signal. The process performed by the control device 25 is not particularly limited. The control device 25 outputs a control signal for transmitting an optical signal corresponding to the performed process to the transmission device 27. For example, the control device 25 performs a process based on a predetermined condition according to information included in the signal received by the reception device 21. For example, the control device 25 performs a process designated by an administrator or the like of the communication device 20 according to information included in a signal received by the reception device 21.

The transmission device 27 acquires a control signal from the control device 25. The transmission device 27 projects a spatial optical signal according to the control signal. The spatial optical signal projected from the transmission device 27 is received by a communication target (not illustrated) of a transmission destination of the spatial optical signal. For example, the transmission device 27 includes a phase modulation-type spatial light modulator. The transmission device 27 may have a light transmission function that is not a phase modulation-type spatial light modulator.

[Transmission Device]

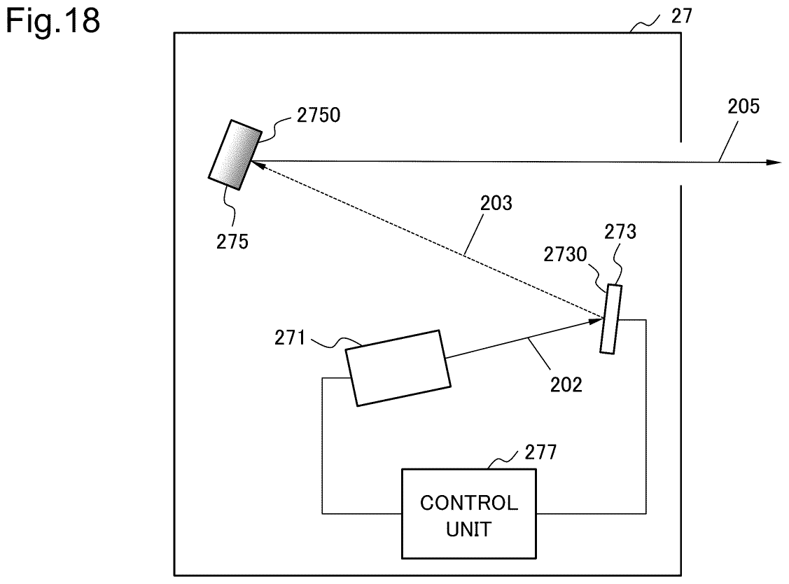

FIG. 18 is a conceptual diagram illustrating an example of a configuration of the transmission device 27. The transmission device 27 includes a light source 271, a spatial light modulator 273, a curved mirror 275, and a control unit 277. FIG. 18 is a side view of the internal configuration of the transmission device 27 when viewed from the side. FIG. 18 is conceptual, and does not accurately represent the positional relationship between the components, the traveling direction of light, and the like.

The light source 271 emits laser light in a predetermined wavelength band under the control of the control unit 277. The wavelength of the laser light emitted from the light source 271 is not particularly limited, and may be selected according to the application. For example, the light source 271 emits laser light in visible or infrared wavelength bands. For example, in the case of near infrared rays of 800 to 900 nanometers (nm), since the laser class can be increased, the sensitivity can be improved by about one digit as compared with other wavelength bands. For example, a high-output laser light source can be used for infrared rays in a wavelength band of 1.55 micrometers (μm). As an infrared laser light source in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set. The light source 271 includes a lens that enlarges the laser light in accordance with the size of the modulation region set in a modulation unit 2730 of the spatial light modulator 273. The light source 271 emits light 202 enlarged by the lens. The light 202 emitted from the light source 271 travels toward the modulation unit 2730 of the spatial light modulator 273.

The spatial light modulator 273 includes the modulation unit 2730. A modulation region is set in the modulation unit 2730. In the modulation region of modulation unit 2730, a pattern (also referred to as a phase image) corresponding to the image displayed by projection light 205 is set according to the control of the control unit 277. The modulation unit 2730 is irradiated with the light 202 emitted from the light source 271. The light 202 incident on the modulation unit 2730 is modulated according to a pattern (phase image) set in modulation unit 2730. Modulated light 203 modulated by the modulation unit 2730 travels toward a reflecting surface 2750 of the curved mirror 275.

For example, the spatial light modulator 273 is achieved by a spatial light modulator including ferroelectric liquid crystal, homogeneous liquid crystal, vertical alignment liquid crystal, or the like. For example, the spatial light modulator 273 can be achieved by liquid crystal on silicon (LCOS). The spatial light modulator 273 may be achieved by a micro electro mechanical system (MEMS). In the phase modulation-type spatial light modulator 273, the energy can be concentrated on the portion of the image by operating to sequentially switch the portion on which the projection light 205 is projected. Therefore, in the case of using the phase modulation-type spatial light modulator 273, when the output of the light source 271 is the same, the image can be displayed brighter than that of other methods.

The modulation region of the modulation unit 2730 is divided into a plurality of regions (also referred to as tiling). For example, the modulation region of the modulation unit 2730 is divided into rectangular regions (also referred to as tiles) having a desired aspect ratio. A phase image is assigned to each of the plurality of tiles set in the modulation region of the modulation unit 2730. Each of the plurality of tiles includes a plurality of pixels. A phase image corresponding to a projected image is set to each of the plurality of tiles. The phase images set to the plurality of tiles may be the same or different.

A phase image is tiled to each of the plurality of tiles allocated to the modulation region of the modulation unit 2730. For example, a phase image generated in advance is set in each of the plurality of tiles. When the modulation unit 2730 is irradiated with the light 202 in a state where the phase images are set for the plurality of tiles, the modulated light 203 that forms an image corresponding to the phase image of each tile is emitted. As the number of tiles set in the modulation unit 2730 increases, a clear image can be displayed. However, when the number of pixels of each tile decreases, the resolution decreases. Therefore, the size and the number of tiles set in the modulation region of the modulation unit 2730 are set according to the application.

Curved mirror 275 is a reflecting mirror having the curved reflecting surface 2750. The reflecting surface 2750 of the curved mirror 275 has a curvature corresponding to the projection angle of projection light 205. The reflecting surface 2750 of the curved mirror 275 may be a curved surface. In the example of FIG. 18, the reflecting surface 2750 of the curved mirror 275 has a shape of a side face of a cylinder. For example, the reflecting surface 2750 of the curved mirror 275 may be a free-form face or a spherical face. For example, the reflecting surface 2750 of the curved mirror 275 may have a shape in which a plurality of curved surfaces is combined instead of a single curved surface. For example, the reflecting surface 2750 of the curved mirror 275 may have a shape in which a curved surface and a flat face are combined.

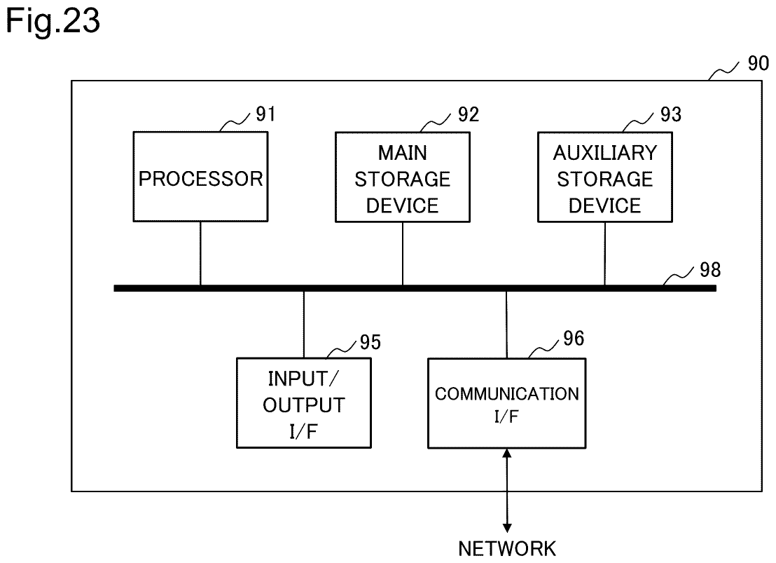

The curved mirror 275 is disposed with the reflecting surface 2750 facing the modulation unit 2730 of the spatial light modulator 273. Curved mirror 275 is disposed on an optical path of the modulated light 203. The reflecting surface 2750 is irradiated with the modulated light 203 modulated by the modulation unit 2730. The light (projection light 205) reflected by the reflecting surface 2750 is enlarged at an enlargement ratio corresponding to the curvature of the reflecting surface 2750 and projected. In the case of the example of FIG. 23, the projection light 205 is enlarged along the horizontal direction (the direction perpendicular to the paper surface of FIG. 18) according to the curvature of the radiation range of the modulated light 203 on the reflecting surface 2750 of the curved mirror 275. The projection light 205 is also enlarged in the vertical direction (the vertical direction in the sheet of FIG. 18) as it goes away from the transmission device 27.

For example, a shield (not illustrated) may be disposed between the spatial light modulator 273 and the curved mirror 275. That is, a shield may be disposed on an optical path of the modulated light 203 modulated by the modulation unit 2730 of the spatial light modulator 273. The shield is a frame that shields unnecessary light components included in the modulated light 203 and defines an outer edge of a display region of the projection light 205. For example, the shield is an aperture in which a slit-shaped opening is formed in a portion through which light forming a desired image passes. The shields transmit light that forms a desired image and shields unwanted light components. For example, the shield shields Oth-order light or a ghost image included in the modulated light 203. Details of the shields will not be described.

The transmission device 27 may be provided with a projection optical system including a Fourier transform lens, a projection lens, and the like instead of the curved mirror 275. The transmission device 27 may be configured to directly project the light modulated by the modulation unit 2730 of the spatial light modulator 273 without including the curved mirror 275 or the projection optical system.

The control unit 277 controls the light source 271 and the spatial light modulator 273. For example, the control unit 277 is achieved by a microcomputer including a processor and a memory. The control unit 277 sets a phase image corresponding to the projected image in the modulation unit 2730 in accordance with the aspect ratio of tiling set in the modulation unit 2730 of the spatial light modulator 273. For example, the control unit 277 sets, in the modulation unit 2730, a phase image corresponding to an image according to a use such as an image display, communication, or distance measurement. The phase image of the projected image may be stored in advance in a storage unit (not illustrated). The shape and the size of the image to be projected are not particularly limited.

The control unit 277 controls the spatial light modulator 273 in such a way that a parameter that determines a difference between a phase of the light 202 with which the modulation unit 2730 of the spatial light modulator 273 is irradiated and a phase of the modulated light 203 reflected by the modulation unit 2730 changes. For example, the parameter is a value related to optical characteristics such as a refractive index and an optical path length. For example, the control unit 277 adjusts the refractive index of the modulation unit 2730 by changing the voltage applied to the modulation unit 2730 of the spatial light modulator 273. The phase distribution of the light 202 with which the modulation unit 2730 of the phase modulation-type spatial light modulator 273 is irradiated is modulated according to the optical characteristics of the modulation unit 2730. The method of driving the spatial light modulator 273 by the control unit 277 is determined according to the modulation method of the spatial light modulator 273.

The control unit 277 drives the light source 271 in a state where the phase image corresponding to the image to be displayed is set in the modulation unit 2730. As a result, the light 202 emitted from the light source 271 is emitted to the modulation unit 2730 of the spatial light modulator 273 in accordance with the timing at which the phase image is set in the modulation unit 2730 of the spatial light modulator 273. The light 202 with which the modulation unit 2730 of the spatial light modulator 273 is irradiated is modulated by the modulation unit 2730 of the spatial light modulator 273. The modulated light 203 modulated by the modulation unit 2730 of spatial light modulator 273 is emitted toward the reflecting surface 2750 of the curved mirror 275.

For example, the curvature of the reflecting surface 2750 of the curved mirror 275 included in the transmission device 27 and the distance between the spatial light modulator 273 and the curved mirror 275 are adjusted, and the projection angle of the projection light 205 is set to 180 degrees. By using two transmission devices 27 configured as described above, the projection angle of projection light 205 can be set to 360 degrees. When part of the modulated light 203 is folded back with a plane mirror or the like inside the transmission device 27, and the projection light 205 is projected in two directions, the projection angle of the projection light 205 can be set to 360 degrees. For example, the transmission device 27 that projects projection light in a direction of 360 degrees and the reception device 21 that receives a spatial optical signal coming from a direction of 360 degrees are combined. With such a configuration, it is possible to achieve a communication device that transmits a spatial optical signal in a direction of 360 degrees and receives a spatial optical signal coming from a direction of 360 degrees.

[Communication Device]

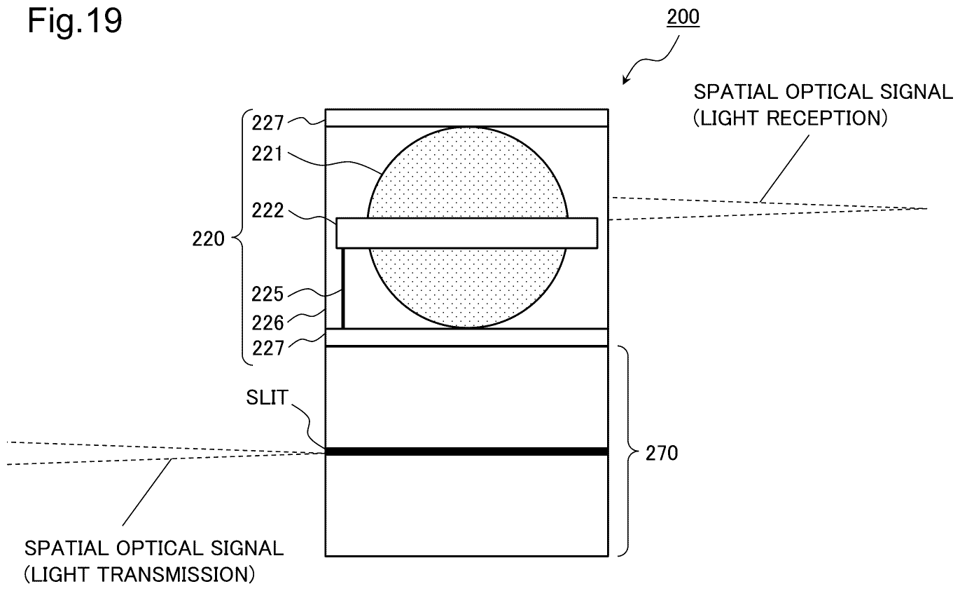

FIG. 19 is a conceptual diagram illustrating an example (communication device 200) of the communication device 20. The communication device 200 includes a receiver 220, a transmitter 270, and a control device (not illustrated). In FIG. 19, a reception circuit and a control device are omitted. The communication device 200 has a configuration in which the receiver 220 having a cylindrical outer shape and the transmitter 270 having a cylindrical outer shape are combined.

The receiver 220 includes a ball lens 221, a light receiver 222, a conductive wire 225, a color filter 226, and a support member 227. The ball lens 221 has the same configuration as the ball lens 11 of the first example embodiment. The upper and lower portions of the ball lens 221 are sandwiched by a pair of support members 227 disposed at the upper side and the lower side. Since the upper and lower parts of the ball lens 221 are not used for transmission and reception of a spatial optical signal, they may be processed into a planar shape in such a way as to be easily sandwiched by the support member 227. The light receiver 222 is disposed in accordance with the condensing region of the ball lens 221 in such a way as to be able to receive the spatial optical signal to be received. The light receiver 222 has the same configuration as the light receiver 12-3 of the third modification according to the first example embodiment. The light receiver 222 may have a configuration different from the third modification according to the first example embodiment. The light receiver 222 includes a light receiving element array including a plurality of light receiving units (not illustrated). The plurality of light receiving elements is connected to a control device (not illustrated) and the transmitter 270 by the conductive wire 225.

The color filter 226 is disposed on the side face of the cylindrical receiver 220. The color filter 226 removes unnecessary light and selectively transmits a spatial optical signal used for communication. A pair of support members 227 is disposed on upper and lower faces of the cylindrical receiver 220. The pair of support members 227 sandwiches the upper and lower parts of the ball lens 221. The light receiver 222 formed in an annular shape is disposed on the emission side of the ball lens 221. The spatial optical signal incident on the ball lens 221 through the color filter 226 is condensed toward the light receiver 222 by the ball lens 221. The optical signal condensed on the light receiver 222 is guided toward the light receiving section of one of the light receiving elements. The optical signal reaching the light receiving section of the light receiving element is received by the light receiving element. A control device (not illustrated) causes the transmitter 270 to transmit a spatial optical signal according to an optical signal received by a light receiving element included in the light receiver 222.

The transmitter 270 can be implemented by the configuration (transmission device 27) in FIG. 18. The transmitter 270 is housed inside a cylindrical housing. A slit opened in accordance with the transmission direction of the spatial optical signal by the transmitter 270 is formed in the cylindrical housing. For example, in a case where the transmitter 270 can transmit the spatial optical signal in the direction of 360 degrees, a slit is formed on the side face of the housing of the transmitter 270 in accordance with the transmission direction of the spatial optical signal.

### Application Example

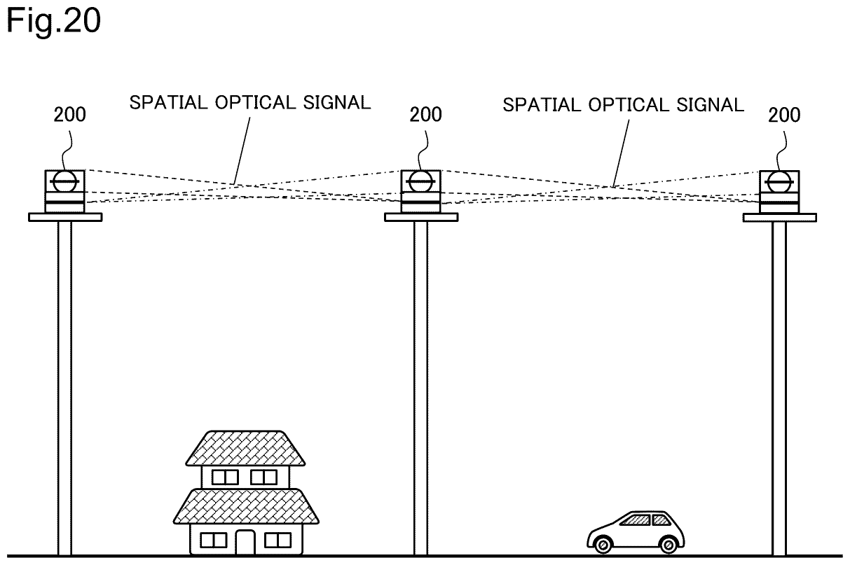

Next, an application example of the communication device 200 of the present example embodiment will be described with reference to the drawings. FIG. 20 is a conceptual diagram for describing the present application example. In the present application example, an example (also referred to as a communication system) of a communication network in which a plurality of communication devices 200 is disposed on an upper part (also referred to as a space above the pillar) of a pillar such as a utility pole or a street lamp disposed in a town will be described.

There are few obstacles in the space above the pillar. Therefore, the space above the pillar is suitable for installing the communication device 200. When the communication device 200 is installed at the same height, the incoming direction of the spatial optical signal is limited to the horizontal direction. Therefore, the light receiving area of the light receiver 222 constituting the receiver 220 can be reduced, and the device can be simplified. The pair of communication devices 200 that transmit and receive the spatial optical signal is disposed in such a way that at least one communication device 200 receives the spatial optical signal transmitted from the other communication device 200. The pair of communication devices 200 may be disposed to transmit and receive spatial optical signals to and from each other. In a case where the communication network of the spatial optical signal is configured by the plurality of communication devices 200, the communication device 200 positioned in the middle may be disposed to relay the spatial optical signal transmitted from another communication device 200 to another communication device 200.

According to the present application example, communication using a spatial optical signal can be performed between the plurality of communication devices 200 each disposed in the space above the pillar. For example, it may be configured in such a way that communication by wireless communication is performed between a wireless device installed in an automobile, a house, or the like, or a base station and the communication device 200 according to communication between the communication devices 200 each disposed in the space above the pillar. For example, the communication device 200 may be connected to the Internet via a communication cable or the like installed on a pillar.

As described above, the communication device according to the present example embodiment includes a reception device, a transmission device, and a control device. The reception device includes a ball lens, a light receiver, and a reception circuit. The ball lens and the light receiver constitute the light receiving device. The ball lens is a spherical lens. The light receiver is disposed in the condensing region of the ball lens. The light receiver includes the light receiving element array and the selection circuit. The light receiving element array has a configuration in which light receiving units are disposed in an array. The light receiving unit includes the light receiving element and the amplifier circuit. The amplifier circuit is associated with one of the plurality of light receiving elements. The selection circuit selects the light receiving unit included in the light receiving element array. The reception circuit obtains a signal received by the light receiving device. The reception circuit decodes the acquired signal. The transmission device transmits a spatial optical signal. The control device acquires a signal based on a spatial optical signal, from another communication device, received by the reception device. The control device performs a process according to the acquired signal. The control device causes the transmission device to transmit a spatial optical signal corresponding to the performed processing.

The light receiving device included in the communication device of the present example embodiment condenses the spatial optical signal transmitted from the communication target by the ball lens. The optical signal condensed by the ball lens is condensed toward at least one of the plurality of light receiving elements constituting the light receiving element array. The light receiving element included in the light receiving unit disposed at the position where the optical signal is condensed receives the condensed optical signal. The light receiving element converts the received optical signal into an electrical signal. The amplifier circuit included in the same light receiving unit as the light receiving element amplifies and outputs the converted electrical signal. According to the communication device of the present example embodiment, it is possible to achieve efficient communication with the communication target according to the efficiently received optical signal.

A communication system according to an aspect of the present example embodiment includes a plurality of the above-described communication device. In a communication system, a plurality of communication devices is disposed to transmit and receive spatial optical signals to and from each other. According to the present aspect, it is possible to achieve a communication network that transmits and receives a spatial optical signal.

### Third Example Embodiment

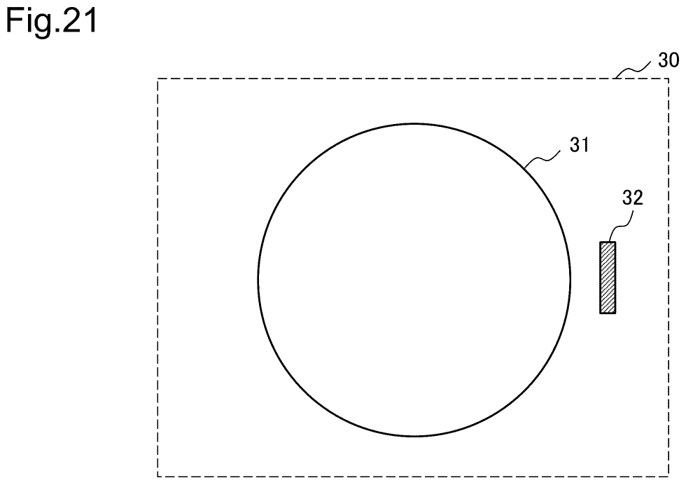

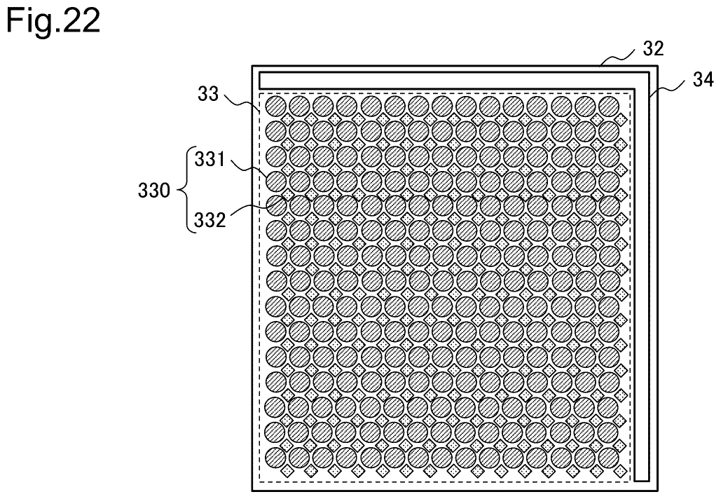

Next, a light receiving device according to a third example embodiment will be described with reference to the drawings. The light receiving device of the present example embodiment has a simplified configuration of the light receiving device of the first example embodiment. FIGS. 21 to 22 are conceptual diagrams illustrating an example of a configuration of a light receiving device 30 according to the present example embodiment. FIG. 21 is a side view of the light receiving device 30 when viewed from the side. FIG. 22 is a conceptual diagram of the light receiving face of a light receiver 32 included in the light receiving device 30 when viewed from the front.

The light receiving device 30 includes a ball lens 31 and the light receiver 32. The ball lens 31 is a spherical lens. The light receiver 32 is disposed in the condensing region of the ball lens 31. The light receiver 32 includes a light receiving element array 33 and a selection circuit 34. The light receiving element array 33 has a configuration in which the light receiving units 330 are disposed in an array. The light receiving unit 330 includes a light receiving element 331 and an amplifier circuit 332. The amplifier circuit 332 is associated with any one of the plurality of light receiving elements 331. The selection circuit 34 selects the light receiving unit 330 included in the light receiving element array 33.

As described above, the light receiving device of the present example embodiment condenses the spatial optical signal transmitted from the communication target by the ball lens. The optical signal condensed by the ball lens is condensed toward at least one of the plurality of light receiving elements constituting the light receiving element array. The light receiving element included in the light receiving unit disposed at the position where the optical signal is condensed receives the condensed optical signal. The light receiving element converts the received optical signal into an electrical signal. The amplifier circuit included in the same light receiving unit as the light receiving element amplifies and outputs the converted electrical signal. According to the reception device of the present example embodiment, an optical signal can be efficiently received.

(Hardware)

Regarding a hardware configuration that performs control and processing according to each example embodiment of the present disclosure, an information processing device 90 (computer) in FIG. 23 will be described as an example. The information processing device 90 in FIG. 23 is a configuration example for performing control and processing of each example embodiment, and does not limit the scope of the present disclosure.

As illustrated in FIG. 23, the information processing device 90 includes a processor 91, a main storage device 92, an auxiliary storage device 93, an input/output interface 95, and a communication interface 96. In FIG. 23 the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing control and processing of each example embodiment. The processor 91 executes the program developed in the main storage device 92. The processor 91 executes the program to execute control and processing according to each example embodiment.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). As the main storage device 92, a nonvolatile memory such as a magnetoresistive random access memory (MRAM) may be configured/added.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. As an interface connected to an external device, the input/output interface 95 and the communication interface 96 may be shared.

An input device such as a keyboard, a mouse, or a touch panel may be connected to the information processing device 90 as necessary. These input devices are used to input of information and settings. In a case where a touch panel is used as the input device, a screen having a touch panel function serves as an interface. The processor 91 and the input device are connected via the input/output interface 95.

The information processing device 90 may be provided with a display device that displays information. In a case where a display device is provided, the information processing device 90 includes a display control device (not illustrated) that controls display of the display device. The information processing device 90 and the display device are connected via the input/output interface 95.

The information processing device 90 may be provided with a drive device.

The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of a hardware configuration for enabling control and processing according to each example embodiment of the present invention. The hardware configuration of FIG. 23 is an example of a hardware configuration for performing control and processing according to each example embodiment and does not limit the scope of the present invention. A program for causing a computer to execute control and processing according to each example embodiment is also included in the scope of the present invention.

A program recording medium in which the program according to each example embodiment is recorded is also included in the scope of the present invention. The recording medium can be achieved by, for example, an optical recording medium such as a compact disc (CD) or a digital versatile disc (DVD). The recording medium may be achieved by a semiconductor recording medium such as a Universal Serial Bus (USB) memory or a secure digital (SD) card. The recording medium may be achieved by a magnetic recording medium such as a flexible disk, or another recording medium. In a case where the program executed by the processor is recorded in the recording medium, the recording medium is a program recording medium.

The components of the example embodiments may be combined in any manner.

The components of the example embodiments may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A light receiving device comprising:
a ball lens; and
a light receiver disposed in a condensing region of the ball lens, wherein
the light receiver includes
a light receiving element array in which light receiving units each of which includes a light receiving element and an amplifier circuit associated with the light receiving element are disposed in an array, and
a selection circuit that selects a light receiving unit included in the light receiving element array.

2. The light receiving device according to claim 1, wherein
the amplifier circuit
is disposed adjacent to the associated light receiving element, the amplifier circuit being in an insensible field formed in a gap between the plurality of light receiving elements disposed in an array.

3. The light receiving device according to claim 2, wherein
the light receiving element array
includes the silicon-based or silicon-germanium-based light receiving elements formed in an array on a silicon substrate.

4. The light receiving device according to claim 3, wherein
the selection circuit includes
a first selection circuit connected to a column selection line used to select, from among the plurality of light receiving units disposed in an array, a plurality of light receiving units disposed in a same column,
a first amplifier that is disposed in association with a plurality of light receiving units disposed in a same row among the plurality of light receiving units disposed in an array, is connected to a plurality of row selection lines connected to an output of at least any of a plurality of the light receiving units disposed in the same row, and adds and amplifies electrical signals input via a plurality of the row selection lines,
a second amplifier to which outputs of a plurality of the first amplifiers are connected, and that adds and amplifies electrical signals input,
a switch disposed for each of a plurality of the first amplifiers, and
a second selection circuit that selects a plurality of the light receiving units disposed in at least any one row among the plurality of light receiving units disposed in an array using a switch disposed for each of the plurality of first amplifiers.

5. The light receiving device according to claim 1, wherein
a plurality of the light receivers are disposed in a condensing region of the ball lens.

6. The light receiving device according to claim 1, wherein
the light receiver
is annularly formed with a light receiving face facing inward, and
is disposed in a condensing region of the ball lens.

7. A reception device comprising:
the light receiving device according to claim 1; and
a reception circuit that acquires a signal received by the light receiving device and decodes the acquired signal.

8. The reception device according to claim 7, wherein
in a search mode, the reception circuit sequentially selects a predetermined number of the light receiving units and identifies a light receiving unit to be used for communication according to outputs of the selected predetermined number of light receiving units, and
in a communication mode, the reception circuit receives an optical signal derived from a spatial optical signal transmitted from a communication target using the light receiving unit identified in the search mode.

9. A communication device comprising:
the reception device according to claim 8;
a transmission device that transmits a spatial optical signal; and
a control device that acquires a signal based on a spatial optical signal, from another communication device, received by the reception device, performs a process according to the acquired signal, and causes the transmission device to transmit a spatial optical signal according to the performed process.

10. A communication system comprising:
a plurality of the communication devices according to claim 9, wherein
the plurality of communication devices
is disposed to transmit and receive spatial optical signals to and from each other.
